(19) United States
(12) Patent Application Publication
(10) Pub. No.: US 2009/0241857 A1
(43) Pub. Date: Oct. 1, 2009

(54) Pet flyer/pet ID holder

(76) Inventor: Parinaz Zolfaghari, Los Angeles, CA (US)

Correspondence Address: Parinaz Zolfaghari, P.o.box 241637, Los Angeles, CA, 90024, US

(21) Appl. No.: 12/079,140

(22) Filed: Mar. 25, 2008

(51) Int. Cl. A01K 27/00; G09F 3/00

(52) U.S. Cl. 119/858; 40/303

(57) ABSTRACT

A lightweight, water resistance, Pet collar or Harness that is able to accommodate pages of papers inside its cylinder easily from the opening (either by zipper, Velcro and /or Zip- lock) or as a tube or cylinder that could be attached to any regular collar or Harness to carry papers inside.

This application claims priority of a provisional patent application No. 61006329 files on Jan. 7, 2008

### BACKGROUND OF THE INVENTION

1. Field of the Invention

The present invention relates to an animal collar that is capable of holding pages of information which will aid in helping identify the lost pet and its owner. The Pet Flyer collar is manufactured in multiple shapes, sizes, styles and colors. The Pet Flyer collar is lightweight, comfortable and water resistant which can be attached traditionally around the pet's neck or as a harness. Additionally, there is an attached loop that facilitates attachment to any commercially available leash. Pet Flyer serves two purposes simultaneously:
1. It is a practical and lightweight collar.
2. It contains every detail about the pet, as well as contact information about its owner on the template papers. The templates are either preprinted and the purchaser will fill-in all of the pertinent details within the pages(s) provided or purchaser uses his/ her own paper and written instruction.

2. Description of the Prior Art

The greatest fear of any pet owner is that we might lose our pet. Posting flyers on street corners, public parks, bulletin boards, etc. are only stopgap measures and locally limited. With Pet Flyer, the animal itself carries the flyer information within the lightweight, water resistant, and comfortable collar.

The invention significantly improves the following Prior Arts:

U.S. Pat. No. 6,305,329 to Levy, Jr., invention called Pet Identification Tag. Pet ID tag is a permanent pet collar identification tag and label system that holds small amounts of information on a tag in the pet collar buckle. Pet Flyer is much more practical in so many ways:

It is not permanent engraved, thereby allowing the papers inside the Pet Flyer to be instantly updated, i.e. every time the pet owner moves or changes his or her information, or that of their beloved pet, they need not buy a newly engraved ID tag. With Pet Flyer the owner simply removes the outdated informational page(s) and replaces it (them) with the updated information. Moreover, Pet Flyer is capable of containing much more information than that currently available on engraved ID tags, which is generally just a name and phone number. Having all the information inside the Pet Flyer at all times is a great way to protect the innocent animal. Additionally, Pet Flyer affords the pet owner the capability of adding a great deal of information about the pet owner as well. Example: If the main contact name and number of the pet owner cannot be reached, secondary names and numbers can be provided within Pet Flyer. If for some reason nobody could be contacted to retrieve the lost pet, all would not be lost. There is space provided within Pet Flyer to add information about he pet such as: Likes, dislikes, medical history and conditions. If for some reason the lost pet were to be adopted by others, all pertinent information about this beloved pet will be known to the new owner.

### EXAMPLE

1) Owner's contact information. Secondary information about other contacts as specified by the pet owner.
2) Veterinary information, such as background sicknesses and vaccinations.
3) Likes and dislikes of the pet (food, behavior, habits, age, etc.)
4) Reward information
5) Etc.

U.S. Pat. No. 7,230,539 to Klein, invention called Pet Identification Tag Internal Cavity for Transponder Capsule. Although this invention greatly improves upon the standard pet identification tag, it does not come close to Pet Flyers comfort and informational capabilities necessary to protect the pet. The aforementioned patented device exchangeable but only as a hanging tag which carries a small amount of information about the pet owner, and there not enough space to carry any personal information about the pet. Instead, it carries the RFID inside the capsule.

RFID capsules have been provided to animal shelters, veterinarians and pet hospitals in the form of a miniature glass capsule which is injected into the animal with a special syringe. One of the examples of an RFID transponder capsule for pets is U.S. Pat. No. 5,025,550 assigned to Trovan Limited. Theses systems typically work by injecting the tiny chip in the form of a fully assembled transponder that is encapsulated in housing, with a typical size of 1-2 mm wide, into the animal's body to read the code to help identify the animal. Although RFID is a good way to protect the pet, it is not logical to think that every pet owner travels to the shelter every time they change their information and update the information on the chip. On the other hand, Pet Flyer carries much more information, personal and otherwise about the pet, in a much more convenient, down to earth and logical method- with no syringe and no pain to the pet. Another invention that improves Tag ID is U.S. Pat. No. 7,225,761 by Reilly. Pet product with device for holding information article. Although, the information inside the device is changeable still it is not as personal, effective and wide-ranging as Pet Flyer. The changeable information is limited to one address and phone number and there is not enough space to write anything about the pet. Beside the device is made of hard plastic and hangs from the collar. As stated, Pet Flyer is a collar, in a lightweight, comfortable form.

### SUMMARY OF THE INVENTION

The present invention provides protection to animals by allowing them to carry all pertinent information about them. This detailed information is carried within a lightweight, comfortable, water resistant enclosed collar. Pet Flyer is a simple, logical and unique enclosure that is sealed with Velcro (hook & loop) and/or a zipper and/or Zip-lock fastener, so simple that even a child or elderly person can attach it to his/her pet or change the insert paper. Depending on the size of the pet collar, Pet Flyers enclosure is able to carry a minimum of two pages of information inside. Everything about the pet is enclosed, from its owners' information to the pet's medical background, to its likes or dislikes. Pet Flyer greatly protects and cares for our pets. Pet Flyer's informational sheets located within the collar may be updated as often as necessary to stay current regarding information about the pet and his/her owner.

The informational pages may be written as if from the pet itself. Example:

Hello

My name is ______. I am a year-old ______ (Breed). I live with ______ (Owner's name) at ______ (Address and other contact information.). I am always with her/him, so if you happen to find me alone that means I am lost. Please contact my loving owner. She/he loves me so very much and will pay a reward with no questions asked. (This part protects the animals from the thieves. Because there are ‘no questions asked’ they could take the pet to the original owner rather than selling it to another stranger).

Another example of information helpful to the finder of the lost pet, the ‘pet's own words’ might be: “Could you please be careful with my front right leg because I hurt it last week and it is still tender. If you couldn't get in touch with my owner please contact: ______” (Alternative contact persons).

This is the sample scenario if the pet is lost or stolen. But, there is another important reason why Pet Flyer is a practical way to protect our pets. If something happens to the owner such as hospitalization, death or some reason, by death or any kind of unforeseen circumstances Pet Flyer allows the pet to ‘speak for itself.’ Its favorite food, personality traits, behavioral habits, allergies or food sensitivities. To date there hasn't been an invention within the marketplace that provides all the information about our beloved pets.

Pet flyer/pet identification holder is releasably attached to the pet, wherein into said enclosure is inserted a pet information sheet the contains pertinent information relating to a particular pet, comprising an elongated enclosure having an opening for inserting and removing said pet information sheet and means for opening and closing the opening. Pet identification collar/pet flyer is made of a material that is selected from the group consisting of transparent plastic, translucent plastic, cloth, leather, and composite fibers. It comprises a first terminating end and a second terminating end, wherein first terminating end has attached a buckle insertion tab having a length that can be cut to allow the pet identification collar to comfortably fit around the neck of a particular pet. It also comprising a D-ring that is attached between the buckle and the first terminating end by a loose stitch wherein to the d-ring is attached a pet leash. Pet identification holder also may attached or be part of the harness leash. The pet information sheet inside the pet identification collar is made of material that is selected from the group consisting of paper, moisture resistant paper, cloth and plastic.

I came up with the idea of Pet Flyer on July 2007. I lost my own dog. In the space of an hour, even while crying, I made hundreds of flyers with my contact information and the reward amount, along with her picture covering my immediate neighborhood. That included almost three streets in each direction. With all that hard work and effort I was still panicked. ‘What if she traveled further or was taken to an area more distant than where my flyers were posted?’ After finding her accidentally but luckily by my own neighbor, I kept on thinking about the panic and awful feeling I had. I wished back then that I could somehow protect my pet by attaching the flyer to her, so that no matter how far she goes my (our) message will carry on. Finally, I came up with the collar/flyer holder. Now, all of my animals; two cats and one dog wear them and I feel much more at ease. Anyone who reads the information within Pet Flyer will get a good idea of who my pet is, because let's face it: No two cats or dogs have the same needs, medications or personality.

### BRIEF DESCRIPTION OF THE DRAWINGS

FIG. 1—is the top plan view of the Pet Flyer/Pet Id Holder collar.

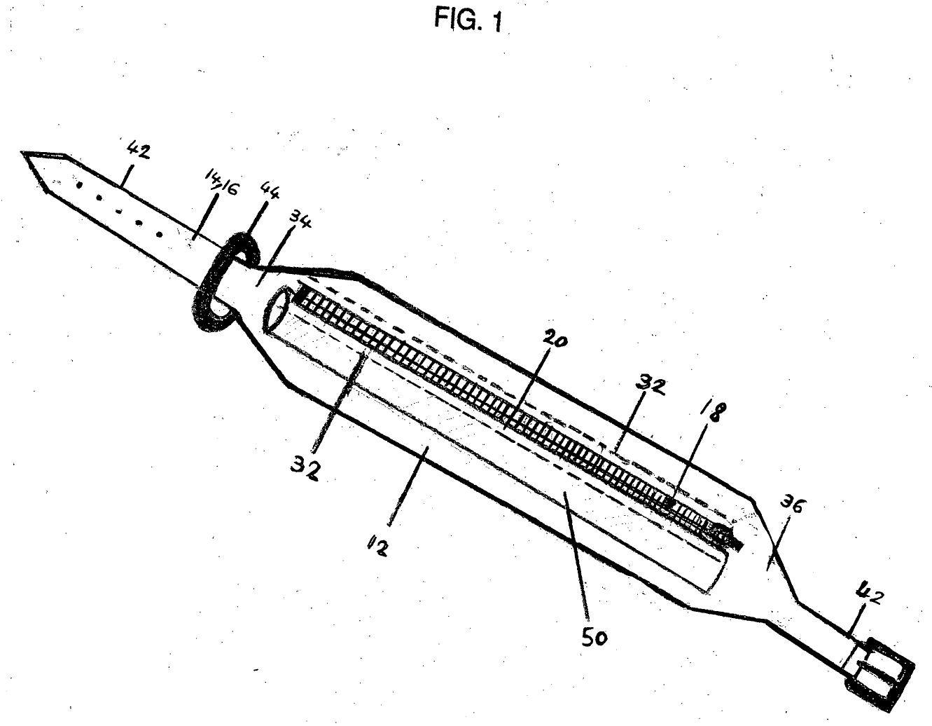

FIG. 2—is the side view of the Pet flyer/Pet Id Holder collar.

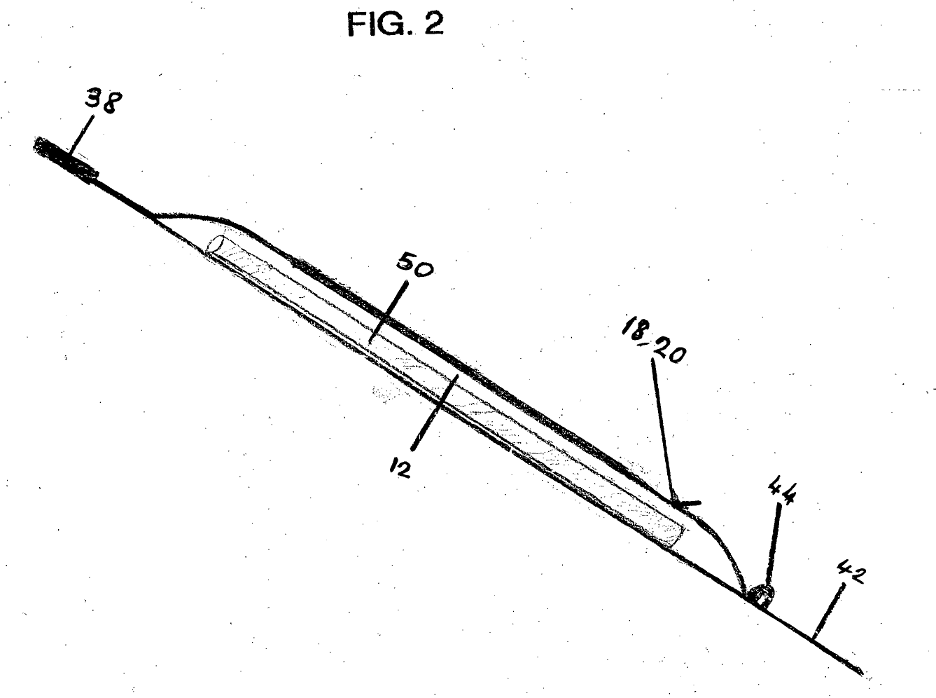

FIG. 3—is a top plan view showing a Harness version of the pet Flyer/Pet Id Holder.

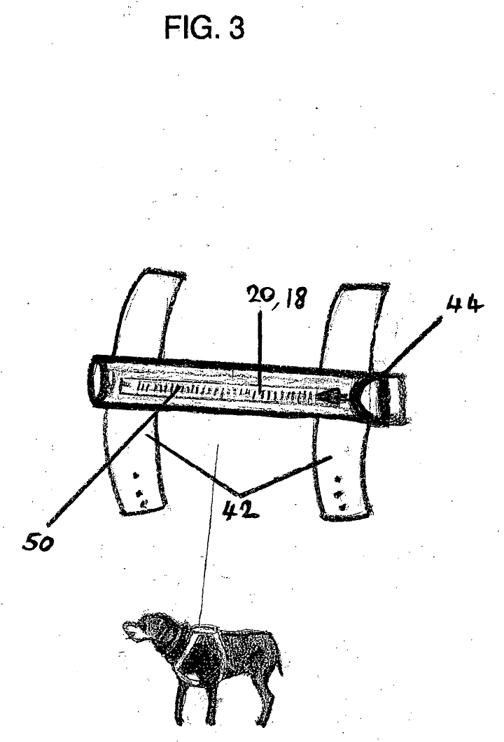

FIG. 4—is a side plan view of the Harness version of the Pet Flyer/ Pet Id Holder.

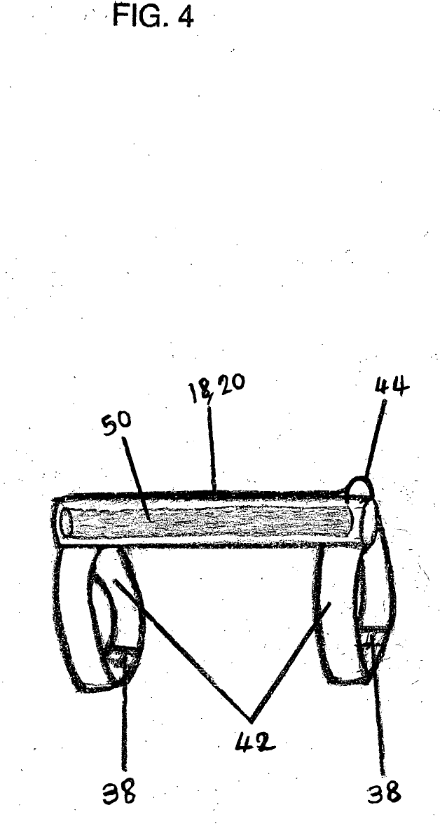

FIG. 5—is a side view of sample of the tube or cylinder that might be attached to any collar by Velcro.

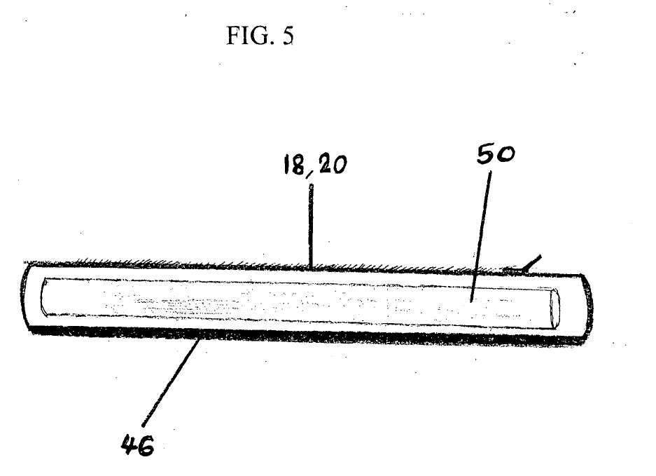

### PET IDENTIFICATION ENCLOSURE

### Element Designators

(For convenience of the Examiner, not part of the specification)
10 Pet Identification Collar (PIC)
12 Elongated Inner Enclosure
14 First Terminating Tab
16 Second Terminating Tab
18 Opening
20 Opening and Closing Means
22
24
26 Elongated Outer Enclosure
28
30 Longitudinal Edge
32 Edge Attachment Means
34 First Terminating End
36 Second Terminating End
38 Buckle
40 Buckle Attachment Loop
42 Buckle Inserting Tab
44 D-Ring
46 Velcro
48
50 Pet Information Sheet

1. A pet identification enclosure that is releasably attached to a pet, wherein into said enclosure is inserted a pet information sheet that contains pertinent information relating to a particular pet.

2. The pet identification enclosure as specified in claim 1 wherein said enclosure is comprised of a pet identification collar comprising an elongated enclosure having an opening for inserting and removing said pet information sheet.

3. The pet identification collar as specified in claim 2 further comprising a means for opening and closing the opening.

4. The pet identification collar as specified in claim 2 further comprising an elongated outer enclosure that surrounds said elongated enclosure, wherein said elongated outer enclosure is made of a material that is selected from the group consisting of transparent plastic, translucent plastic, cloth, leather and composite fibers.

5. The pet identification collar as specified in claim 4 wherein said elongated outer enclosure further comprises a first terminating end and a second terminating end, wherein the first terminating end has attached a buckle and the second terminating functions as a buckle insertion tab having a length that can be cut to allow the pet identification collar to comfortably fit around the neck of a particular pet.

6. The pet identification collar as specified in claim 5 further comprising a D-ring that is attached between the buckle and the first terminating end by a loose stitch wherein to the D-ring is attached a pet leash.

7. The pet identification collar as specified in claim 2 wherein said pet information sheet includes as a minimum the following pet information:
a) name,
b) age,
c) breed,
d) medical data, and
e) owner contact data.

8. A pet identification collar comprising:
a) an elongated inner enclosure having:
(1) a first termination tab and a second termination tab,
(2) an opening that extends between the first termination tab and the second terminating tab,
(3) means for opening and closing the opening,
b) an elongated outer enclosure that is dimensioned to radially surround said elongated inner enclosure and having:
(1) an opening having longitudinal edges that terminate adjacent to the opening on said elongated inner enclosure and that are attached thereto by an edge attachment means,
(2) a first terminating end and a second terminating end that are respectively attached to the first and second terminating tabs on said elongated inner enclosure,
(3) means for attaching the first and second terminating ends to the respective first and second terminating tabs,
(4) means for releasably attaching the first terminating end to the second terminating end when said pet identification collar is placed around the neck of a pet, and
c) a pet information sheet that includes pertinent information pertaining to a lost or injured pet, wherein said pet information sheet is inserted into the opening on said elongated inner enclosure.

9. The pet identification collar as specified in claim 8 wherein said elongated inner enclosure is made of a material that is selected from the group consisting of nylon, rayon, cotton, leather and plastic.

10. The pet identification collar as specified in claim 9 wherein said elongated inner or outer enclosure is produced in various colors.

11. The pet identification collar as specified in claim 9 wherein said means for opening and closing the longitudinal opening on said elongated inner enclosure is selected from the group consisting of a zipper, a hook and loop fastener and a Zip-Lock™ fastener.

12. The pet identification collar as specified in claim 8 wherein said elongated outer enclosure is made of a material that is selected from the group consisting of transparent plastic, translucent plastic, cloth, leather and composite fibers.

13. The pet identification collar as specified in claim 8 wherein said means for attaching the longitudinal edges of said elongated outer enclosure to said elongated inner enclosure comprises a stitch or an adhesive.

14. The pet identification collar as specified in claim 8 wherein said means for attaching the first terminating end to the second terminating end of said elongated outer enclosure comprises:
a) a buckle that is attached to a buckle attachment loop that is formed when the first terminating end is folded over and attached by a stitch or an adhesive, and
b) a buckle insertion tab that is formed with the second terminating end having a length that can be cut to allow the pet identification collar to comfortably fit around the neck of a particular pet.

15. The pet identification collar as specified in claim 14 further comprising a D-ring that is attached between the buckle and the first terminating end by a looped-stitch, wherein to the D-ring is attached to a pet leash.

16. The pet identification collar as specified in claim 8 wherein said elongated inner enclosure or said elongated outer enclosure further comprises indicia.

17. The pet identification collar as specified in claim 8 wherein said pet information sheet includes at least the following pet information:
a) name,
b) age,
c) breed,
d) medical data, and
e) owner contact data.

18. The pet identification collar as specified in claim 17 wherein said pet information sheet is made of a material that is selected from the group consisting of paper, moisture resistant paper, cloth and plastic.

19. The pet identification collar as specified in claim 8 wherein said pet identification collar is attached around a pet harness by a collar attachment means.

20. The pet identification collar as specified in claim 19 wherein said collar attachment means is selected from the group consisting of a hook and loop fastener, a set of complimentary snaps and stitching.
